(19) United States
(12) Patent Application Publication
(10) Pub. No.: US 2016/0356062 A1
(43) Pub. Date: Dec. 8, 2016

(54) Latching System and Handle for Enclosures

(71) Applicant: Hoffman Enclosures, Inc., Anoka, MN (US)

(72) Inventors: Csaba Andrasfi, Oakdale, MN (US); Harry Lakoduk, Ramsey, MN (US); Nathan Westby, Zimmerman, MN (US)

(21) Appl. No.: 15/174,615

(22) Filed: Jun. 6, 2016

Related U.S. Application Data
(60) Provisional application No. 62/171,709, filed on Jun. 5, 2015.

(51) Int. Cl. E05B 65/52; E05B 13/00; E05B 7/00; E05C 3/16; E05C 9/08

(52) U.S. Cl. CPC E05B 65/5269; E05C 3/16; E05C 9/08; E05B 7/00; E05B 13/002

(57) ABSTRACT

Embodiments of the invention provide a latching assembly for an enclosure with an enclosure frame, a latching feature, and a door. A handle can include a handle body and at least one actuation arm with a first engagement feature, and can be pivotably attached to the door to rotate about a pivot axis. A latching mechanism supported by the door can include a rod extending along a rod axis that is substantially parallel to the pivot axis, a second engagement feature engaging the first engagement feature, when the handle is rotated about the pivot axis, to rotate the rod about the rod axis, and a catch attached to the rod. The catch can engage the latching feature of the enclosure, when the rod is rotated in a first rod direction about the rod axis, to latch the door to the enclosure frame.

### RELATED APPLICATIONS

This application claims priority to U.S. Provisional Patent Application No. 62/171,709, which was filed on Jun. 5, 2015.

### BACKGROUND

Enclosures, such as cabinet enclosures used to house electrical and datacom equipment, can include latching systems to secure doors of the enclosures in a closed orientation. External handles for such latching systems can be used to in order release the door from the closed orientation.

Handles in conventional latching systems are twisted about a horizontal axis in order to actuate extended rods. Depending on the direction the handles are twisted, the actuated rods engage or disengage recesses or holes on the enclosure in order to latch or unlatch the door. With such an arrangement, warping, sagging, or other misalignment of the door can result in poor engagement of the rods with the handle in the latching position as well as other performance deficiencies. It may also be difficult to customize conventional latching systems, with respect to the number and placement of latching elements and other features. Further, conventional handles may need to be reversed when the hinging arrangement of the door is reversed. This can add time and expense to door installation.

### SUMMARY

Some embodiments of the invention provide a latching system for an enclosure with an enclosure frame, a latching feature, and a door. A handle can include a handle body and at least one actuation arm with a first engagement feature, and can be pivotably attached to the door to rotate about a pivot axis. A latching mechanism can be supported by the door, and can include a rod, a second engagement feature, and a catch attached to the rod. The rod can extend along a rod axis that is substantially parallel to the pivot axis. The second engagement feature can engage the first engagement feature, when the handle is rotated about the pivot axis, to rotate the rod about the rod axis. The catch can engage the latching feature of the enclosure, when the rod is rotated in a first rod direction about the rod axis, to latch the door to the enclosure frame.

Some embodiments of the invention also provide latching system for an enclosure with an enclosure frame, a latching feature, and a door. A handle mechanism can include a handle base attached to the door, and a handle. The handle can include a handle body, a first elongate actuation arm extending away from the handle body, and a second elongate actuation arm extending away from the handle body. The handle body can be substantially symmetrical relative to an axis of symmetry, and can be pivotably attached to the door via the handle base to rotate about a pivot axis that is substantially perpendicular to the axis of symmetry. The first elongate actuation arm and the second elongate actuation arms can include, respectively, a first engagement feature and a second engagement feature. A latching mechanism supported by the door can include a rod extending along a rod axis that is substantially parallel to the pivot axis, and a third engagement feature, a fourth engagement feature, and a catch, each attached to the rod. The first engagement feature can engage the third engagement feature, and the second engagement feature can engage the fourth engagement feature, so that rotating the handle about the pivot axis rotates the rod about the rod axis. The catch can engage the latching feature of the enclosure, when the rod is rotated in a first rod direction about the rod axis, to latch the door to the enclosure frame.

Some embodiments of the invention provide a paddle-style handle for use with a latching system for an enclosure with a door, where the latching system includes a rod extending along a rod axis, a first engagement feature attached to the rod, and a second engagement feature attached to the rod. A handle body can be substantially symmetrical relative to an axis of symmetry that is substantially perpendicular to the rod axis, and can be configured to pivot relative to a pivot axis when the handle body is attached to the door. A first elongate actuation arm can extend away from the handle body substantially perpendicularly to the pivot axis, with a third engagement feature proximate a free end of the first elongate actuation arm. A second elongate actuation arm can extend away from the handle body substantially perpendicularly to the pivot axis, with a fourth engagement feature proximate a free end of the second elongate actuation arm. The third engagement feature can be configured to engage the first engagement feature, and the fourth engagement feature can be configured to engage the second engagement feature, so that rotating the handle body about the pivot axis rotates the rod about the rod axis.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front, top, right isometric view of a handle mechanism for an enclosure door, according to one embodiment of the invention, with a handle of the handle mechanism in a closed orientation;

FIG. 2 is a front, top, right isometric view of the handle mechanism of FIG. 1 with the handle in an open orientation;

FIG. 3 is a rear, top, left isometric view of the handle mechanism of FIG. 1 with the handle in an open orientation;

FIG. 4 is a top plan view of the handle mechanism of FIG. 1;

FIG. 5 is a left elevation view of the handle mechanism of FIG. 1;

FIG. 6 is a right elevation view of the handle mechanism of FIG. 1, from an opposite side as FIG. 5;

FIG. 7A is a front, top, right isometric view of a handle of the handle mechanism of FIG. 1;

FIG. 7B is a rear, bottom, left isometric view of the handle of FIG. 7A;

FIG. 8 is a rear, top isometric view of a handle retention mechanism of the handle mechanism of FIG. 1, with the handle in the closed orientation;

FIG. 9 is a front, top, right isometric view of actuation blocks of the handle retention mechanism of FIG. 8;

FIG. 10 is a rear, top isometric view of the handle retention mechanism of FIG. 8, with the handle in a released orientation;

FIG. 11 is a rear, top, left isometric view of the handle retention mechanism of FIG. 8, with the handle in the open orientation;

FIG. 12 is a front, top, right isometric view of a latching mechanism for use with the handle mechanism of FIG. 1, according to one embodiment of the invention;

FIG. 13 is a rear, top, left isometric view of the latching mechanism of FIG. 12;

FIG. 14 is a rear, top, right isometric view of the latching mechanism of FIG. 12;

FIG. 15 is a rear, top, right isometric view of a latching assembly according to one embodiment of the invention, with the latching assembly including the handle mechanism of FIG. 1 and the latching mechanism of FIG. 12;

FIG. 16 is a rear, top, left isometric view of the latching assembly of FIG. 15 engaging an enclosure frame to latch a door to the enclosure frame;

FIG. 17 is a top, front, left isometric view of a handle mechanism for an enclosure door, according to one embodiment of the invention, with a handle of the handle mechanism in a closed orientation; and

FIG. 18 is a top, front, left isometric view of a handle mechanism for an enclosure door, according to one embodiment of the invention, with a handle of the handle mechanism in a closed orientation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Among other benefits, embodiments of the invention can generally provide a latching system in rotating a handle about a pivot axis can pivot a rod about a parallel rod axis, in order to latch or unlatch an enclosure door. In some embodiments, for example, a paddle-style handle can include a handle body that is generally symmetrical about a horizontal axis. The handle can include at least two actuation arms that extend away from the handle body, and can be pivotably attached to a door of an enclosure so that the handle can pivot about a vertical pivot axis. When the handle is attached to the door (e.g., via a symmetrical handle base), the actuation arms can extend through the door to engage a vertically oriented rod, so that pivoting the handle about the vertical axis, between an open configuration and a closed configuration, simultaneously pivots the rod about a vertical rod axis. This arrangement can be useful, for example, in order to provide reliable latching for the door, even if the door becomes warped or otherwise deformed. Further, the symmetrical configuration of the handle body can allow the handle to be used on either a left side or a right side of the enclosure door, without requiring the handle to be reconfigured. This can be useful, for example, to allow the latching system to be easily used for different hinge configurations of the enclosure door.

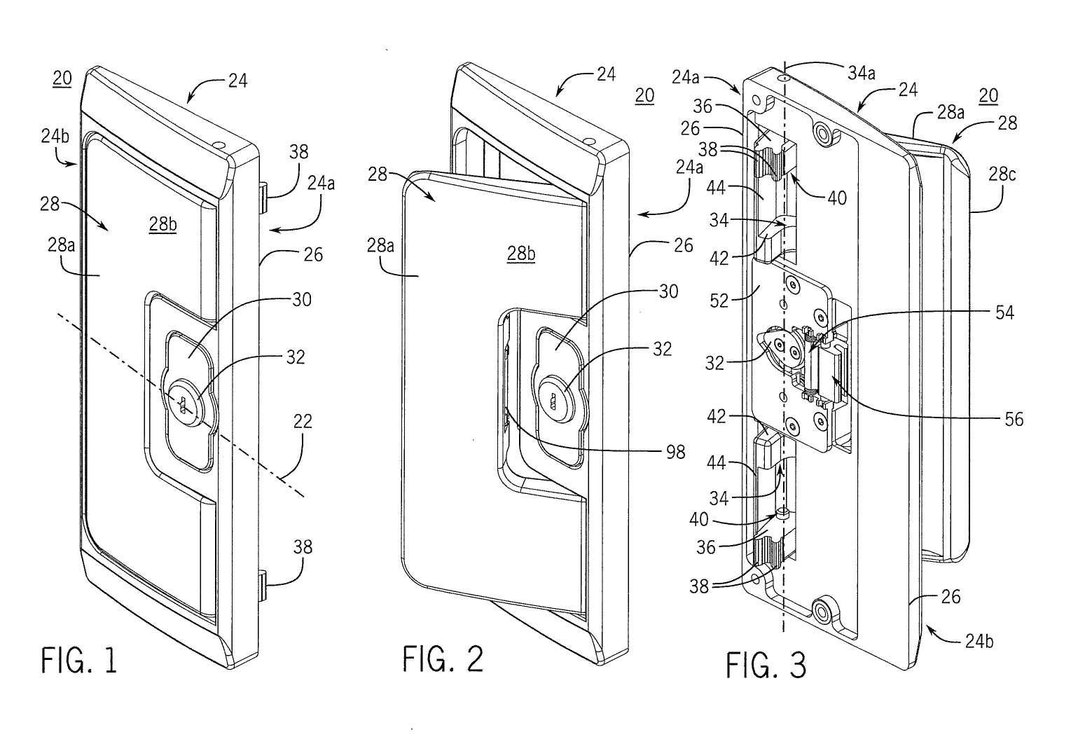

FIGS. 1 through 6 illustrate a handle mechanism 20 according to one embodiment of the invention. Generally, the handle mechanism 20 is adapted to be attached (e.g., screwed onto) an enclosure door (not shown in FIGS. 1-6) in order to control latching and unlatching of the door, and to provide a gripping feature for a user to swing the unlatched door open or closed.

The handle mechanism 20 exhibits a generally symmetrical form with respect to a axis 22, which is generally horizontal relative to a typical installed orientation of the handle mechanism 20 on an enclosure door (see, e.g., FIG. 14). A base 24 of the handle mechanism 20 exhibits a generally tapered profile, with a right side 24a of the base 24 extending farther away from a back edge 26 of the base 24 than does a left side 24b of the base 24.

The handle mechanism 20 further includes a handle 28, a depressible button 30 for releasing the handle 28, and a lock 32. The handle 28 is pivotably mounted to the base 24 at pivot points 34 (see FIG. 3), such that the handle 28 can rotate between the closed orientation depicted in FIG. 1 to the open orientation illustrated in FIGS. 2 and 3. With the base 24 attached (e.g., screwed) to the relevant enclosure door, the handle 28 can accordingly pivot relative to the base 24 and the door about a generally vertical pivot axis 34a (see FIG. 3)

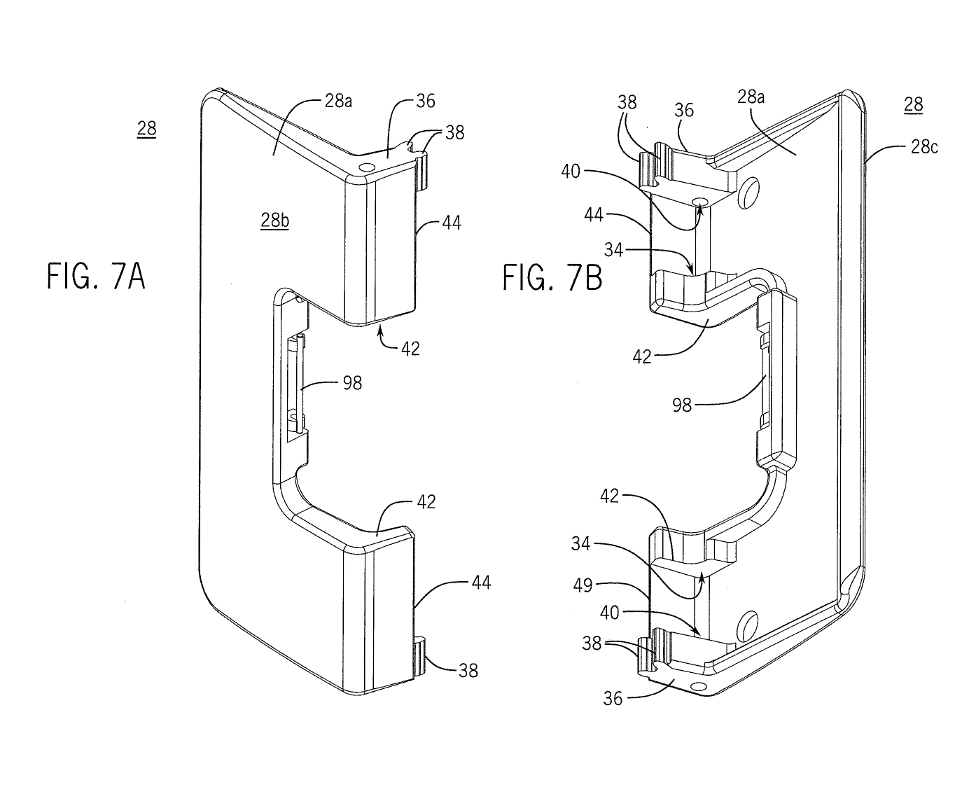

In the embodiment illustrated, the handle 28 includes a handle body 28a configured as a generally C-shaped paddle handle, with a front face 28b with a lip 28c that can be gripped by a user to pull the handle 28 and thereby unlatch and move the relevant door. As illustrated in particular in FIGS. 7A and 7B, the handle 28 also includes a set of actuation arms 36 that extend away from the handle body 28a in a direction that is generally perpendicular to the pivot axis 34a.

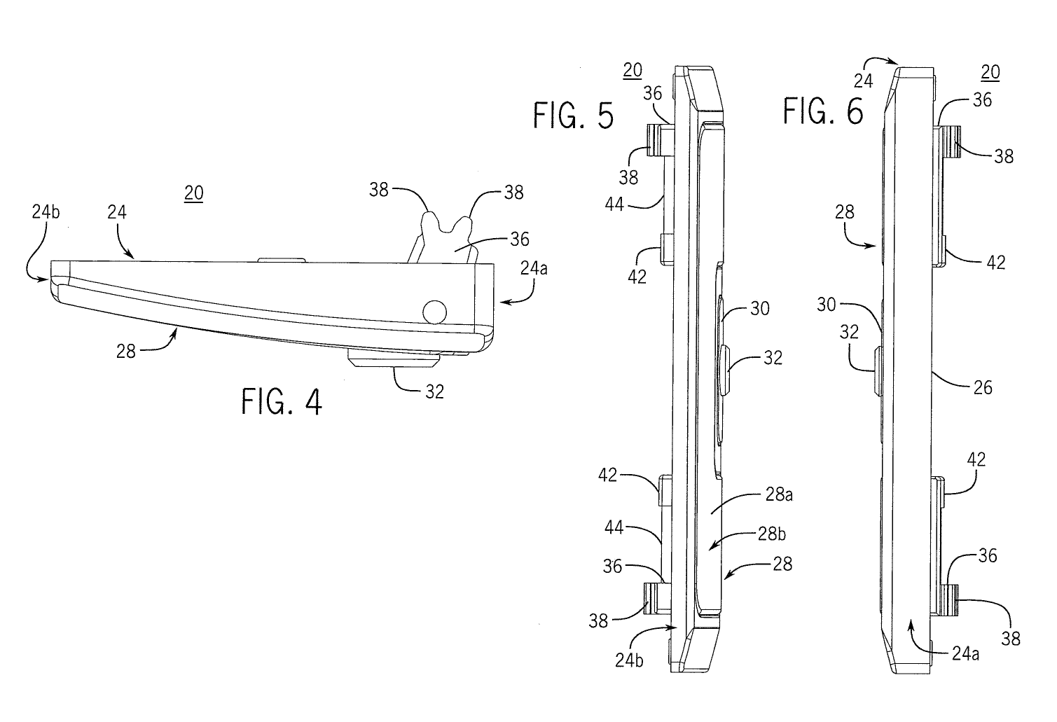

Generally, each of the actuation arms 36 can be provided with engagement features, which can engage corresponding features of a latching mechanism in order to rotate a latch rod when the handle 28 is pivoted about the pivot axis 34a. In the embodiment illustrated in FIGS. 1 through 7B, each of the actuation arms 36 extends rearward of the back edge 26 of the base 24 (see, e.g., FIG. 4) and includes, at a free end of the actuation arm 36, multiple actuation fingers 38 (e.g., generally configured as teeth of a partial gear). Accordingly, as also discussed below, the actuation fingers 38 can extend through a relevant door to engage a latching mechanism and thereby pivot the relevant rod.

In the embodiment illustrated, the actuation arms 36 also provide pivot points 40 for the handle 28, with respect to the base 24 of the handle mechanism 20. For example, the actuation arms 36 can include pivot pins or holes (not shown) that are aligned with the pivot points 40 and that pivotably engage corresponding pivot holes or pins (not shown) on the base 24. This can be useful, for example, in order to ensure that the handle 28 is appropriately secured to the base 24. In some embodiments, actuation arms may be configured not to provide pivotable connections with the base 24.

In some embodiments, some arms extending from the handle body 28a may not include engagement features. For example, arms 42 (see, e.g., FIGS. 7A and 7B), integrally connected with the actuation arms 36 by respective side walls 44, can help to create a generally robust pivotal connection between the handle 28 and the base 24, but do not include engagement features such as actuation fingers. In some embodiments, the arms 42 can alternatively be configured as actuation arms, and can accordingly be equipped with actuation fingers or other engagement features. In some embodiments, a different number of arms (or actuation arms) can be used.

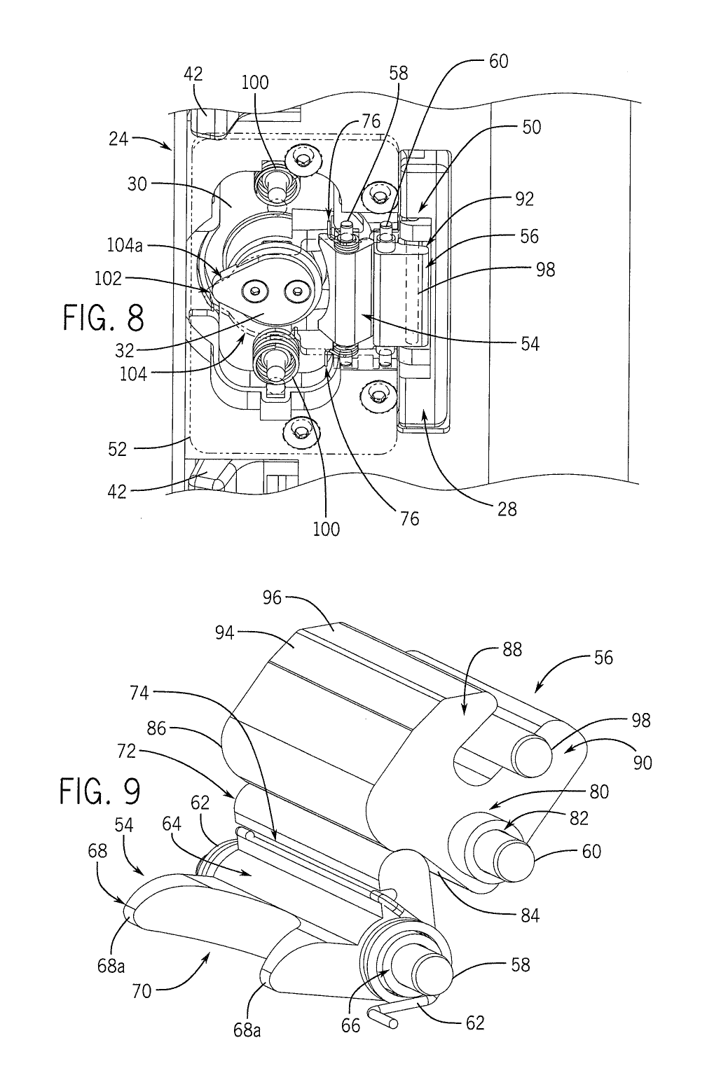

In some embodiments, a latching system can include a handle retention mechanism, which can help to retain a handle (e.g., the handle 28) in a closed orientation (e.g., as illustrated in FIG. 1) and can release the handle from the closed orientation to allow a user to move the handle (and the corresponding door) to an open orientation. As one example, FIGS. 8 through 11 illustrate a handle retention mechanism 50 for the handle mechanism 20, with a cover plate 52 rendered transparently in order to show various internal components of the handle retention mechanism 50. To retain (and controllably release) the handle 28, two actuation blocks 54 and 56 are pivotably mounted to the base 24 with respective pins 58 and 60. A set of biasing springs 62 seated on the actuation block 54 and the base 24 urge the actuation block 54 in the clockwise direction, as viewed from above.

As illustrated in FIG. 9 in particular, the actuation block 54 includes a main body 64 with a bore 66 to receive the pin 58. (In some embodiments, the pin 58 can be integrally formed with the main body 64.) A tapered extension 68, with two prongs 68a on opposite sides of a central, rounded recess 70, extends away from the main body 64 in a first, generally radial, direction. A rounded extension 72 extends away from the main body 64 in a second, also generally radial, direction that is approximately perpendicular to the first direction.

As noted above, the actuation block 54 is biased by a set of biasing springs 62. A groove 74 extending along the extension 72 provides a seat for ends of the springs 62 such that the springs 62 can provide a rotational bias to the actuation block 54. Opposite ends of the springs 62 are seated in respective grooves 76 in the cover plate 52 (see FIG. 8).

The actuation block 56 includes a main body 80 with a bore 82 to receive the pin 60. (In some embodiments, the pin 60 can be integrally formed with the main body 80.) An engagement face 84 extends generally tangentially to the bore 82 then transitions to a lip 86 that angles towards the actuation block 54 in the installed orientation (i.e., when the two blocks 54 and 56 are installed in the handle retention mechanism 50). A set of flanges 88 and 90 extend away from the lip 86 to form a retaining groove 92. The retaining groove 92 is configured to slidably receive a retaining pin 98 that is mounted to the handle 28 along the central portion of the handle body 28a (see also FIGS. 7A and 7B). The flange 88 is configured with a tapered end, including angled outer faces 94 and 96 that can help to guide the retaining pin 98 into the retaining groove 92. For example, as the handle 28 is being closed, the retaining pin 98 can contact one or both of the angled faces 94 and 96. This contact, in turn, can cause the actuation block 56 to rotate, thereby moving the flange 88 out of the path of the retaining pin 98 such that the retaining pin 98 can enter the retaining groove 92 (see, e.g., FIG. 8).

As illustrated in FIG. 8, when the handle 28 is in the closed and retained orientation (as also illustrated in FIG. 1), the retaining pin 98 on the handle 28 is received in the retaining groove 92 of the actuation block 56. Accordingly, the actuation block 56 must rotate counterclockwise, as viewed from above, in order to release the retaining pin 98 (i.e., to place the handle 28 in a closed, but released orientation) and thereby allow the handle 28 to pivot open. However, in the orientation depicted in FIG. 8, the rounded extension 72 of the actuation block 54 contacts the engagement face 84 of the actuation block 56 in order to prevent counterclockwise rotation of the actuation block 56. The rounded extension 72 is urged into place by the rotational bias of the springs 62, such that the springs 62 provide a retaining force to keep the handle 28 in the closed orientation. Further, the lip 86 generally prevents the actuation block 56 from rotating past the extension 72 (and vice versa). Accordingly, the actuation blocks 54 and 56 and the retaining pin 98 prevent the handle from moving to the open orientation.

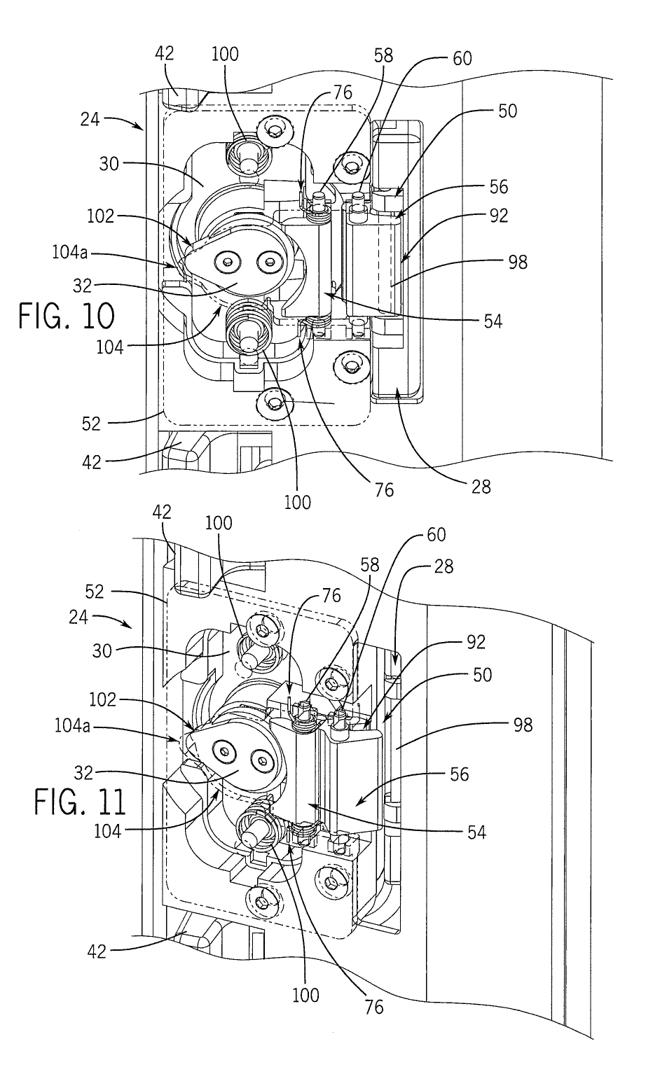

In order to release the handle to the open orientation, the button 30 can be depressed from the exterior of the handle mechanism 20. As depicted in FIG. 10, when the button 30 is pressed with sufficient force to overcome the biasing force of a set of biasing springs 100, a back face of the button 30 contacts the pronged extension 68 and urges the actuation block 54 to rotate in a counterclockwise direction, as viewed from above. This rotation of the actuation block 54 can cause the extension 72 to clear the lip 86 of the actuation block 56, such that the extension 72 no longer blocks counterclockwise rotation of the actuation block 56. Accordingly, as illustrated in FIG. 11, the actuation block 56 can rotate to release the retaining pin 98 from the retaining groove 92, and the handle 28 can be rotated to the open orientation.

In some embodiments, forces from the door (e.g., from the elastic expansion of a gasket) or other sources can cause the handle 28 to automatically pivot slightly outward, when the retaining pin 98 is released from the actuation block 56 (e.g., when the button 30 is sufficiently depressed), such that the lip 28c (see FIG. 2) can be easily grasped by an operator. The handle can then be further rotated to a fully open orientation (see, e.g., FIG. 2), with the retaining pin 98 being thereby moved to be fully outside of the retaining groove 92 (see, e.g., FIG. 11). In some embodiments, these forces from the door can also cause the door to open slightly. Together (or separately) this partial opening of the door or of the handle 28 can provide a visual indicator to an operator that the door has been unlatched (e.g., by the pushing of the button 30).

With the lock 32 unlocked, as illustrated in FIGS. 8, 10, and 11, a locking cam 102 can be aligned with an extended portion 104a of an opening 104 in the cover plate 52. Accordingly, when the button 30 is pressed, the locking cam 102 can move past the cover plate 52 and the button 30 can contact the extension 68 to rotate the actuation block 54. In contrast, with the lock 32 locked (not shown) the locking cam 102 would not be aligned with the extended portion 104a of the opening 104 and would be blocked by the cover plate 52. Accordingly, when the lock 32 is locked, the button 30 cannot be depressed sufficiently to release the handle 28 (e.g., as described above) and the door cannot be unlatched and opened.

Generally, a latching mechanism for use with a handle mechanism according to the invention can include a latch rod that extends substantially in parallel, but offset from, a pivot axis for the handle mechanism. In some embodiments, for example, a latching mechanism can include a vertically extending rod for use with a handle mechanism with a vertical pivot axis (e.g., the pivot axis 34a illustrated in FIG. 3). Further, one or more engagement features configured to engage with the engagement features of the handle mechanism (e.g., the actuation fingers 38 illustrated in FIGS. 3 through 7B), so that rotating a handle of the handle mechanism about the pivot axis causes a rotation of the latch rod about a parallel axis.

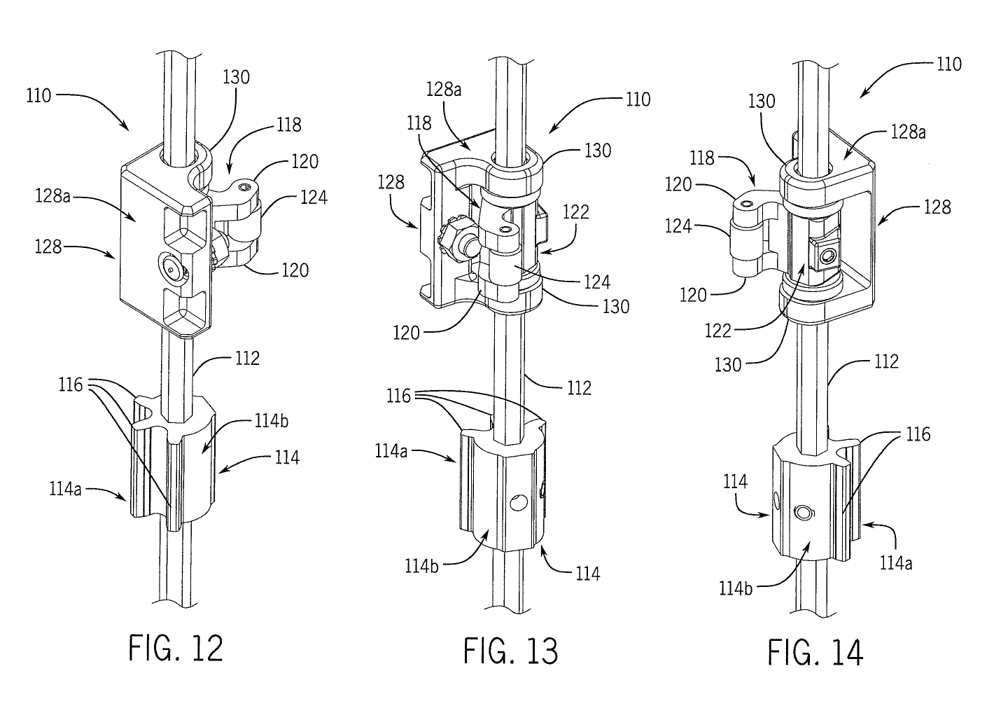

As one example, FIGS. 12 through 14 illustrate a latching mechanism 110 for use with the handle mechanism 20. Generally, the latching mechanism 110 includes a latch rod 112 configured to extend vertically along the back of a door of an enclosure (not shown) on which the latching mechanism 110 has been installed. The latch rod 112 can be configured with various lengths, including lengths approximately equal to the vertical height of the relevant door, depending on the needs of a particular application.

In the embodiment illustrated, the latch rod 112 is a hexagonal rod. In other embodiments, other types of rods can be used. For example, in some embodiments, a fully round latch rod can be used in place of the hexagonal latch rod 112.

One or more actuation bodies, with corresponding engagement features, can be secured to the latch rod 112 in order to engage the engagement features on the relevant handle mechanism and thereby translate pivotal movement of the handle mechanism (e.g., movement of the handle 28 of the handle mechanism 20) into a corresponding movement of the latch rod 112. In the embodiment illustrated in FIGS. 12 through 14, an actuation body is configured as a partial gear in the form of a rounded, elongate sleeve 114 that is rotationally fixed relative to the latch rod 112 and includes toothed and un-toothed portions 114a and 114b, respectively. The un-toothed portion 114b is generally rounded, without protrusions, and the toothed portion 114a includes multiple actuation fingers 116 that extend generally radially outward away from the latch rod 112. As also discussed below, the actuation fingers 116 exhibit a generally complementary geometry to the actuation fingers 38 (see, e.g., FIGS. 7A and 7B), so that the actuation fingers 38 and 116 can be intermeshedly engaged to translate rotational movement of the handle 28 into rotational movement of the latch rod 112 (and vice versa).

In order to secure the relevant door to the relevant enclosure (e.g., the relevant enclosure frame), a catch 118 is also secured to the latch rod 112. Similarly to the sleeve 114, the catch 118 is rotationally fixed relative to the latch rod 112, so that rotation of the latch rod 112 also rotates the catch 118.

Generally, a catch can include a variety of structures configured to engage a latching feature of an enclosure (e.g., a flange or other feature on an enclosure frame) in order to latch the relevant door in a closed orientation relative to the enclosure. In the embodiment illustrated in FIGS. 12 through 14, the catch 118 includes a pair of bent latching arms 120 that extend generally away from a mounting sleeve 122 secured to the latch rod 112. The latching arms 120, as illustrated, exhibit a generally arcuate profile, although other configurations are possible.

In order to engage a latching feature of an enclosure, a roller 124 is supported between the latching arms 120. Due generally to the bend of the latching arms 120, as well as the ability of the roller 124 to move easily along surfaces of a latching feature, the catch 118 can tend to pull a door towards an enclosure when the catch 118 is activated. For example, with a door in a partially open orientation (e.g., an orientation in which the door is not fully seated on a relevant flange or has not fully compressed a relevant gasket), when the latching arms 120 are rotated to engage the relevant latching feature (e.g., by an operator moving the handle 20 to the closed orientation), the roller 124 can engage the latching feature and, as the catch 118 is generally rotated to a fully latched orientation, can pull the door towards the latching feature and the fully closed orientation. This can be useful, for example, where warping, sagging, or other misalignment of the door resist the door being fully closed.

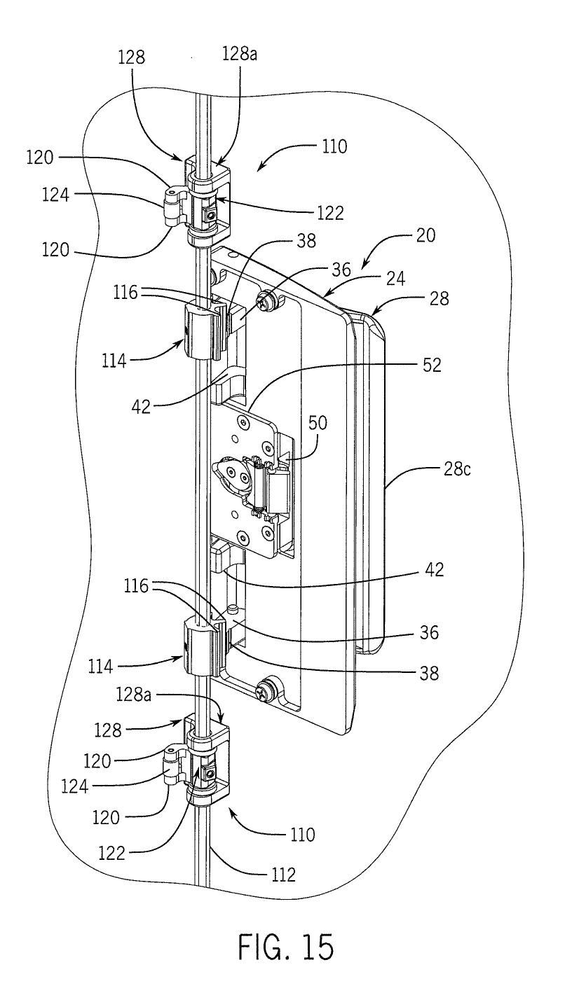

As illustrated in FIG. 15, in some embodiments, a complete latching system 140 can include two of the latching mechanisms 110, each installed for use with the handle mechanism 20, with the latch rod 112 secured to a door 126 of an enclosure so that at least some the fingers 116 of the sleeves 114 are engaged (e.g., intermeshed) with at least some of the fingers 38 on the actuation arms 36 of the handle 28. In this way, when the handle 28 is rotated open or closed, the fingers 38 of the handle 28 engage the fingers 116 on the sleeve 114 to cause the latch rod 112 to also rotate in parallel with, but in an opposite direction from, the handle 28. This, in turn, causes the catch 118 to rotate, such that the door 126 can be unlatched or latched, respectively.

In the embodiment illustrated, the latch rod 112 is secured to the door 126 via a set of mounting brackets 128, each including a mounting portion 128a, as well as a pair of parallel lugs 130 through which the latch rod 112 extends (see also FIGS. 12 through 14). In some embodiments, the parallel lugs 130 can provide strength and stability for latching operations generally, as well as to the latch rod 112 specifically. For example, as illustrated in FIGS. 12 through 15, each of the mounting sleeves 122, along with the corresponding sets of the latching arms 120, is generally disposed between corresponding sets of the lugs 130. With the mounting brackets 128 secured to the door 126 (see FIG. 15), the lugs 130 can accordingly help to secure the mounting sleeves 122 (and the latching arms 120) at a predetermined position along the latch rod 112. Further, the lugs 130 can help to resist deformation (e.g., bowing) of the latch rod 112 relative to the door 126 near the mounting sleeves 122, thereby helping to provide a generally stronger connection between the door 126 and the enclosure frame when the latching arms 120 are in the latched orientation. In other embodiments, other configurations can be used.

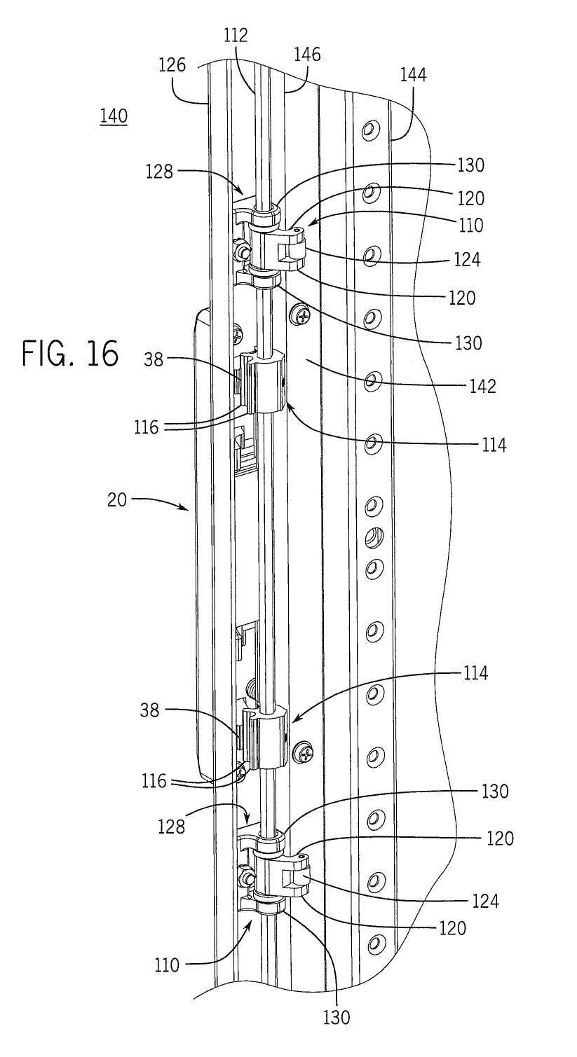

As also noted above, FIG. 15 illustrates an example configuration of the complete latching assembly 140. In the embodiment illustrated, a first instance of the latching mechanism 110, with a corresponding first set of the latching arms 120 and a first instance of the mounting bracket 128, is disposed on the latch rod 112 generally above the handle mechanism 20. Similarly, a second instance of the latching mechanism 110, with a corresponding second set of latching arms 120 and a second instance of the mounting bracket 128, is disposed on the latch rod 112 generally below the handle mechanism 20. With this configuration, the latching assembly 140 can engage a latching feature of an enclosure (e.g., a perimeter flange 142 of an enclosure frame 144, as illustrated in FIG. 16) at at least two points in order to latch the door 126 in a closed orientation. In other configurations, additional (or alternative) sets of the latching arms 120 (with or without additional mounting brackets) or various other latching features can be disposed at various other locations on the latch rod 112. In this way, for example, the location and number of latch points for the latching assembly 140 can be customized for particular applications, with essentially infinite variability.

In the embodiment illustrated in FIGS. 15 and 16, the latching arms of the latching mechanisms 110 are arranged to rotate counterclockwise (as viewed from above), in order to engage the flange 142 (see FIG. 16) and thereby latch the door 126 in the closed orientation. Correspondingly, opening the handle 28 in the latching assembly 140 by rotating the handle 28 in a counterclockwise direction (as viewed from above) rotates the latch rod 112 in a clockwise direction to release the latching mechanisms 110 from the flange 142 and thereby unlatch the door 126.

In particular, FIG. 16 illustrates the latching alms 120 of the latching mechanism 110 having been rotated in the counterclockwise direction (as viewed from above), so that the roller 124 engages the flange 142 of the enclosure frame 144, in order to latch the door 126 in the closed orientation. As also noted above, during the latching operation, the counterclockwise rotation of the latching arms 120 can tend to pull the flange 142 and the door 126 together, such that appropriate latching of the door 126 can be achieved even if the door 126 is warped, sagging, or otherwise misaligned with the enclosure frame 144.

When the handle mechanism 20 is moved to the open orientation (e.g., when the handle 28 is rotated in the counterclockwise direction), the actuation arms 36 on the handle 28 can then rotate the latch rod 112 (e.g., in the clockwise direction), such that the latching arms 120a and roller 124 release the flange 142 and the door 126 can be opened.

In the embodiment illustrated in FIG. 16, the door 126 can compress a gasket 146 between the door 126 and the enclosure frame 144, when the door 126 is latched in the closer orientation, in order to provide a seal around the edges of the door 126. In such a case, elastic forces resulting from the compression of the gasket 146 can tend to urge the door 126 towards the open orientation. Accordingly, the latching mechanism 110 can be configured with sufficient gripping strength to hold the door 126 against the elastic forces from the gasket 146 (and other sources). Further, in some embodiments, the forces from the gasket (and other sources) can be further resisted by retention of the handle 28 in the closed orientation by the handle retention mechanism 50 (see FIGS. 8 through 11).

When the button 30 is pushed to release the handle 28 into a released orientation (see FIG. 10), the elastic force from the gasket 146 can then usefully urge the door 126 away from the flange 142, thereby rotating the latching anus 120 somewhat and, correspondingly, rotating the handle 28 from the fully closed orientation towards the fully open orientation. Accordingly, by way of the mechanical connection between the latching arms 120 of the latching mechanism 110 and the actuation arms 36 of the handle 28, the release of the gasket 146 from compression can correspondingly move the handle 28 so that the lip 28c (see FIG. 2) of the handle 28 can be easily grasped by an operator. Further, these (and other) forces can also cause the door 126 to move from a fully closed (and latched) orientation to a somewhat open orientation. In some embodiments, this partial movement of the handle 28 or the door 126 towards the respective fully open orientations, upon an operator pressing the button 30, can usefully provide a visual indication to an operator that the door 126 has been unlatched.

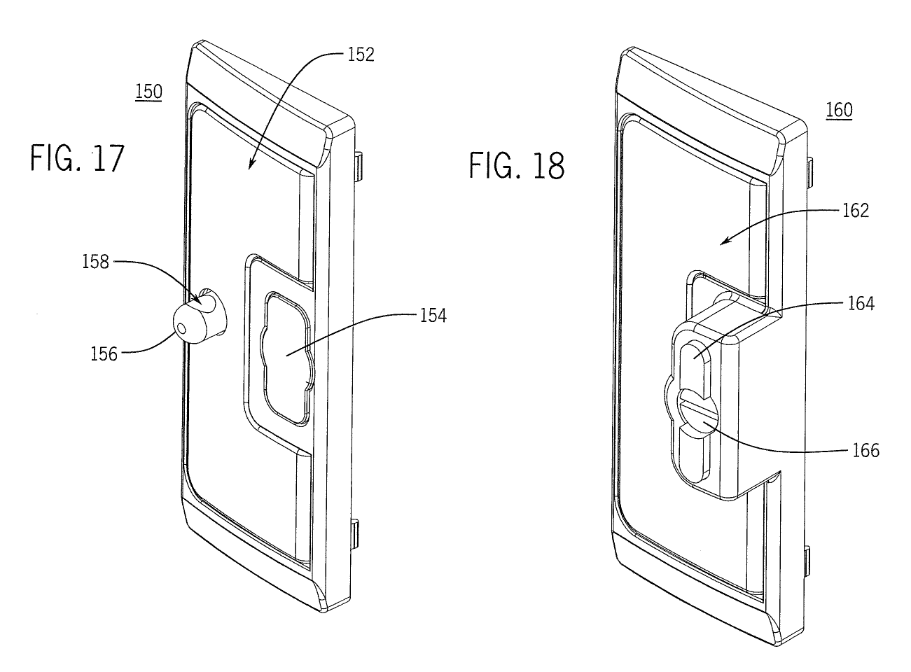

In some embodiments, other configurations for a handle mechanism are possible. For example, FIG. 17 illustrates a handle mechanism 150 with a handle 152 and a depressible button 154 that are configured to operate similarly to the handle 28 and the button 30 (see FIGS. 1 through 11). In contrast to the handle mechanism 20, however, the handle mechanisms 150 includes a padlock post 156 instead of a lock similar to the lock 32. A padlock or similar mechanism can accordingly be inserted through a bore 158 in the post 156 in order to lock the handle 152 in the closed orientation.

As another example, FIG. 17 illustrates a handle mechanism 160 with a handle 162 and a button 164 that are configured to operate similarly to the handle 28 and the button 30 (see FIGS. 1 through 7B). In contrast to the handle mechanism 20, however, the handle mechanism 160 includes a differently configured lock 166.

In some embodiments, a handle mechanism can be configured without a button for releasing the handle. With respect to the handle mechanism 20 of FIG. 1, for example, alternative embodiments may not include the button 30 for release of the handle 28. In such an embodiment, the handle 28 can be configured to be opened simply by grasping the lip 28c or otherwise directly engaging the handle 28. Similarly, some embodiments can have handle retention mechanisms that differ from the handle retention mechanism 50 of FIG. 7. For example, a different spring-loaded retainer, a detent arrangement (not shown), or other configuration can be used in order to secure the handle 28 in a closed orientation and to release the handle 28, when desired, in order to allow the relevant door to be opened.

The previous description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

1. A latching system for an enclosure with an enclosure frame, a latching feature, and a door, the latching system comprising:
a handle including a handle body and at least one actuation arm with a first engagement feature, the handle being pivotably attached to the door to rotate about a pivot axis; and
a latching mechanism supported by the door, the latching mechanism including:
a rod extending along a rod axis that is substantially parallel to the pivot axis;
a second engagement feature engaging the first engagement feature, when the handle is rotated about the pivot axis, to rotate the rod about the rod axis; and
a catch attached to the rod, the catch engaging the latching feature of the enclosure, when the rod is rotated in a first rod direction about the rod axis, to latch the door to the enclosure frame.

2. The latching system of claim 1, wherein the handle body is substantially symmetrical about a first axis of symmetry that is substantially perpendicular to the pivot axis.

3. The latching system of claim 1, wherein the first engagement feature includes a first actuation finger; and
wherein the second engagement feature includes a second actuation finger that engages the first actuation finger.

4. The latching system of claim 3, wherein the first actuation finger includes a plurality of first actuation fingers.

5. The latching system of claim 4, herein the second actuation finger includes a plurality of second actuation fingers.

6. The latching system of claim 3, wherein the second actuation finger is included on a gear attached to the rod.

7. The latching system of claim 6, wherein the gear is formed as a partial gear, with a perimeter that includes an un-toothed portion and a toothed portion that includes the second actuation finger.

8. The latching system of claim 7, wherein the partial gear includes a sleeve that is elongate relative to a diameter of the rod; and
wherein the second actuation finger includes a plurality of second actuation fingers that are included on the sleeve.

9. The latching system of claim 1, wherein the at least one actuation arm includes a first actuation arm and a second actuation arm.

10. The latching system of claim 1, wherein the handle body includes a C-shaped paddle handle.

11. The latching system of claim 10, wherein the C-shaped paddle handle at least partly surrounds at least one of a lock and a handle release button.

12. The latching system of claim 1, wherein rotating the handle about the pivot axis in a first handle direction rotates the rod about the rod axis in the first rod direction to move the catch into engagement with the latching feature of the enclosure; and
wherein rotating the handle about the pivot axis in a second handle direction rotates the rod about the rod axis in a second rod direction to move the catch out of engagement with the latching feature of the enclosure.

13. The latching system of claim 12, wherein the first handle direction is opposite the first rod direction.

14. The latching system of claim 12, wherein, with the door in a partially open orientation, rotating the handle about the pivot axis in the first handle direction causes the catch to engage the latching feature of the enclosure to pull the door into a fully closed orientation.

15. The latching system of claim 14, wherein the catch includes at least one bent latching arm that supports a roller; and
wherein the roller engages the latching feature of the enclosure.

16. The latching system of claim 1, wherein a mounting body with a first lug and a second lug attaches the rod to the door, with the rod extending through the first lug and the second lug; and
wherein the catch is attached to the rod between the first lug and the second lug.

17. A latching system for an enclosure with an enclosure frame, a latching feature, and a door, the latching system comprising:
a handle mechanism including:
a handle base attached to the door; and
a handle including a handle body, a first elongate actuation arm extending away from the handle body, and a second elongate actuation arm extending away from the handle body;
the handle body being substantially symmetrical relative to an axis of symmetry, and being pivotably attached to the door via the handle base to rotate about a pivot axis that is substantially perpendicular to the axis of symmetry;
the first elongate actuation arm including a first engagement feature proximate a free end of the first elongate actuation arm; and
the second elongate actuation arm including a second engagement feature proximate a free end of the second elongate actuation arm; and
a latching mechanism supported by the door, the latching mechanism including:
a rod extending along a rod axis that is substantially parallel to the pivot axis;
a third engagement feature attached to the rod;
a fourth engagement feature attached to the rod; and
a catch attached to the rod;
the first engagement feature engaging the third engagement feature, and the second engagement feature engaging the fourth engagement feature, so that rotating the handle about the pivot axis rotates the rod about the rod axis; and
the catch engaging the latching feature of the enclosure, when the rod is rotated in a first rod direction about the rod axis, to latch the door to the enclosure frame.

18. The latching system of claim 17, wherein each of the first engagement feature, the second engagement feature, the third engagement feature, and the fourth engagement feature includes a respective plurality of actuation fingers.

19. A paddle-style handle for use with a latching system for an enclosure with a door, the latching system including a rod extending along a rod axis, a first engagement feature attached to the rod, and a second engagement feature attached to the rod, the paddle-style handle comprising:
a handle body that is substantially symmetrical relative to an axis of symmetry, the axis of symmetry being substantially perpendicular to the rod axis, the handle body being configured to pivot relative to a pivot axis when the handle body is attached to the door;
a first elongate actuation arm extending away from the handle body substantially perpendicularly to the pivot axis, with a third engagement feature proximate a free end of the first elongate actuation arm; and
a second elongate actuation arm extending away from the handle body substantially perpendicularly to the pivot axis, with a fourth engagement feature proximate a free end of the second elongate actuation arm;
the third engagement feature being configured to engage the first engagement feature, and the fourth engagement feature being configured to engage the second engagement feature, so that rotating the handle body about the pivot axis rotates the rod about the rod axis.

20. The paddle-style handle of claim 19, wherein each of the third engagement feature and the fourth engagement feature includes a respective plurality of actuation fingers.
